(19) United States
(12) Patent Application Publication
(10) Pub. No.: US 2025/0109021 A1
(43) Pub. Date: Apr. 3, 2025

(54) MCMB PREPARATION METHOD

(71) Applicant: KILLINGTON MATERIALS INC., Seoul (KR)

(72) Inventors: Jinkyu HAN, Hanam-si (KR); Stephen David PASK, Dormagen (DE); Hwanbeom LEE, Seoul (KR)

(21) Appl. No.: 18/730,205

(22) PCT Filed: Jan. 21, 2022
(86) PCT No.: PCT/KR22/01080

§ 371 Date: Jul. 18, 2024

(30) Foreign Application Priority Data
Jan. 19, 2022 (KR) 10-2022-0007951

(51) Int. Cl. C01B 32/05

(52) U.S. Cl. CPC C01B 32/05; C01P 2004/32; C01P 2004/61

(57) ABSTRACT

The present invention relates to an MCMB preparation method, and the method may comprise the steps of a) pre-treating raw pitch, b) mixing the pre-treated pitch with a salt, c) pulverizing and stirring the pitch and salt mixture, (d) heating and stirring the pulverized mixture at a temperature of 150-300° C. for 30-180 minutes to pyrolyze and polymerize the raw pitch and accordingly prepare mesophase pitch, e) cooling the heated and stirred mixture and removing a salt therefrom, and f) post-processing the mesophase pitch from which a salt has been removed to prepare MCMB.

### TECHNICAL FIELD

The present invention relates to a mesophase carbon microbead (MCMB) preparation method, and more specifically, to an MCMB preparation method capable of reducing the cost of preparing MCMB.

### BACKGROUND ART

Generally, MCMB is prepared by heating pitch at high temperatures. Pitch exhibits optically isotropic properties, but when pitch is heat-treated at 380° C. or higher, polymerization occurs simultaneously with pyrolysis, and MCMB having optically anisotropic properties is thereby produced. When heat treatment continues, the MCMB particles gradually grow, and when the temperature is above a certain level, the microbeads coalesce to form coke. The MCMB produced in this heat treatment process has a well-developed crystal structure due to the stacking of aromatic rings and thus has excellent electrical and mechanical properties, so it is used as a basic material in the process of manufacturing negative electrode materials for lithium secondary batteries and various high-strength, high-density carbon materials.

Patent Publication No. 10-1999-0083663 (Method for producing particulate carbon, published on Dec. 6, 1999) discloses a method of mixing pitch and a polymer resin, allowing the resulting mixture to react at 500 to 600° C., pulverizing the resulting material obtained by cooling the mixture and then classifying the pulverized material to obtain powder.

However, since the quality of the final product is significantly affected by the quality of the pitch itself, this method requires the use of anisotropic pitch, or when isotropic pitch is used, an operation of converting it to anisotropic pitch is required, and the yield is reduced depending on the content of a thermosetting resin.

In addition, when converting isotropic pitch to anisotropic pitch, there was a problem that preparation costs increased because heat treatment was performed at a high temperature of 500 to 600° C.

### DISCLOSURE

### Technical Problem

The technical problem to be solved by the present invention in consideration of the above-described conventional problems is to provide an MCMB preparation method capable of reducing the energy input when preparing anisotropic pitch using isotropic pitch.

In addition, another object of the present invention is to provide an MCMB preparation method capable of relatively lowering the reaction temperature of pitch and shortening the time required for the reaction, thereby improving productivity and reducing preparation costs.

### Technical Solution

An MCMB preparation method according to a preferred embodiment of the present invention may include the steps of: a) pre-treating raw pitch; b) mixing the pre-treated pitch with a salt; c) pulverizing and stirring the mixture of the pitch and salt; d) heating and stirring the pulverized mixture at a temperature of 150 to 300° C. for 30 to 180 minutes to pyrolyze and polymerize the raw pitch and consequently prepare mesophase pitch; e) cooling the heated and stirred mixture and removing the salt therefrom; and f) post-processing the mesophase pitch from which the salt has been removed to prepare MCMB.

In an embodiment of the present invention, the raw pitch may be isotropic pitch with a softening point of 150° C. or 115° C.

In an embodiment of the present invention, Step a) may be to homogenize dried raw pitch to a particle size of 106 μm or less through sieving and dry the homogenized raw pitch in an oven.

In an embodiment of the present invention, the salt of Step b) may be a water-soluble metal chloride.

In an embodiment of the present invention, the metal chloride may be a mixture of aluminum chloride and sodium chloride in a molar ratio of 3:2 to 1:1.

In an embodiment of the present invention, the mixing ratio of the raw pitch and the metal chloride may be 5 to 30% by weight of the raw pitch and 70 to 95% by weight of the salt.

In an embodiment of the present invention, Step e) may be to remove the water-soluble salt by washing with distilled water.

In an embodiment of the present invention, Step f) may be to dry the mesophase pitch in a vacuum atmosphere and then prepare MCMB through solvent extraction.

### Advantageous Effects

The MCMB preparation method of the present invention has the effect of improving productivity and reducing preparation costs by preparing MCMB by inducing a polymerization reaction at a temperature lower than 380° C., conventionally used for pitch, using a molten salt.

In addition, the present invention can prepare anisotropic MCMB while using isotropic pitch, thereby reducing raw material costs and raw material processing costs.

### DESCRIPTION OF DRAWINGS

FIG. 1 shows a process flowchart of an MCMB preparation method according to a preferred embodiment of the present invention.

FIGS. 2 to 12 show the Raman shift graphs illustrating the results of various experimental examples of the present invention.

### MODES OF THE INVENTION

Hereinafter, the MCMB preparation method of the present invention will be described in detail with reference to the attached drawings.

The embodiments of the present invention are provided to describe the present invention more fully to those skilled in the art, and the embodiments described below may be modified into various other forms, and the scope of the present invention is not limited to the embodiments described below. Rather, these embodiments are provided to make the present invention more faithful and complete and to fully convey the spirit of the present invention to those skilled in the art.

The terminology used herein is used to describe particular embodiments and is not intended to limit the present invention. Singular forms used herein may include plural forms, unless the context clearly indicates otherwise. In addition, “comprise” and/or “comprising” used herein specify(ies) the presence of mentioned shapes, numbers, steps, operations, members, elements and/or groups and do(es) not preclude the possibility of the presence or addition of one or more other shapes, numbers, steps, operations, members, elements and/or groups. The term “and/or” used herein includes any one of the listed items and all combinations of one or more.

Although the terms “first,” “second,” and the like are used herein to describe various members, regions, and/or portions, it is obvious that these members, regions, layers, and/or portions are not limited by these terms. These terms do not imply a specific sequence or hierarchy, and are only used to distinguish one member, region, or portion from another member, region, or portion. Therefore, a first member, region, or portion described below may refer to a second member, region, or portion without departing from the teachings of the present invention.

Hereinafter, embodiments of the present invention will be described with reference to drawings schematically illustrating the embodiments of the present invention. In the drawings, for example, modifications in the illustrated shapes may be expected depending on manufacturing techniques and/or tolerances. Therefore, embodiments of the present invention should not be construed as being limited to the specific shapes of the regions illustrated in the present specification, but should include, for example, changes in shapes resulting from manufacturing.

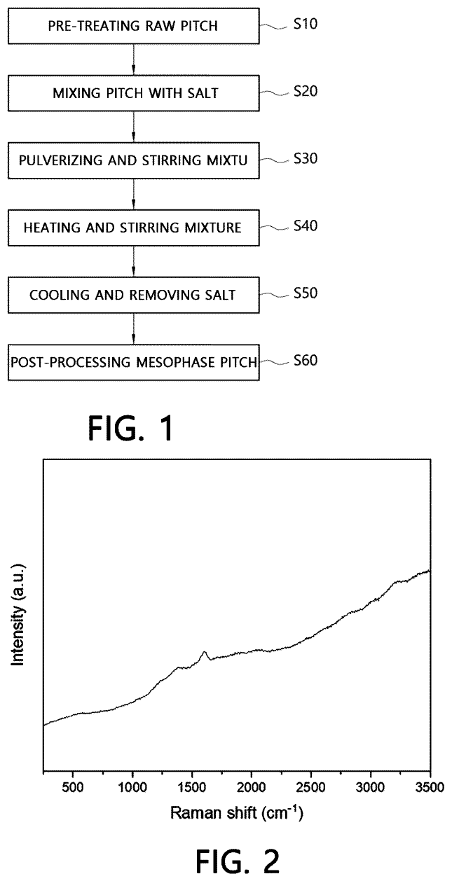

FIG. 1 shows a process flowchart of an MCMB preparation method according to a preferred embodiment of the present invention.

Referring to FIG. 1, the method of the present invention includes the steps of: a) pre-treating raw pitch (S10); b) mixing the pre-treated pitch with a salt (S20); c) pulverizing and stirring the mixture of the pitch and salt (S30); d) heating and stirring the pulverized mixture at a temperature of 150 to 300° C. for 30 to 180 minutes to pyrolyze and polymerize the raw pitch and consequently prepare mesophase pitch (S40); e) cooling the heated and stirred mixture and removing the salt therefrom (S50); and f) post-processing the mesophase pitch from which the salt has been removed to prepare MCMB (S60).

Hereinafter, the configuration and operation of the MCMB preparation method of the present invention configured as described above will be described in more detail.

First, raw pitch is pre-treated as in Step S10.

At this time, in the pretreatment, the dried raw pitch is homogenized to a particle size of 106 μm or less through sieving, and the homogenized raw pitch is dried in an oven. At this time, the drying conditions are heating to 40° C. in a vacuum atmosphere and drying completely. At this time, the raw material pitch is isotropic pitch.

At this time, the drying time may be adjusted depending on the amount of raw pitch.

Next, dried raw pitch is mixed with a salt as in Step S20.

At this time, the salt may include sodium chloride, and is preferably a mixture of sodium chloride and a metal chloride. In particular, aluminum chloride (AlCl₃) may be used as the metal chloride.

The mixing ratio of aluminum chloride and sodium chloride is preferably a molar ratio of 3:2 to 1:1.

The reason for using the aluminum chloride and sodium chloride is because both are water-soluble and thus it is relatively easy to remove the salts in the subsequent process.

In other words, although a mixture of aluminum chloride and sodium chloride is described in the detailed description of the present invention, any water-soluble metal salt is applicable.

The mixing ratio of the pre-treated pitch and the salt is 5 to 30% by weight of the pre-treated pitch and 70 to 95% by weight of the salt.

Next, the mixture of the pitch and salt is pulverized and stirred as in Step S30.

At this time, a ball mill may be used for pulverizing and stirring, and the particle size of the mixture is homogenized and the mixture is stirred so that the pitch and salt are homogeneously mixed.

Next, the pulverized mixture is heated and stirred at a temperature of 150 to 300° C. for 30 to 180 minutes to pyrolyze and polymerize the pitch to produce mesophase pitch. Preferably, the heating temperature is 250° C. This is a condition for obtaining MCMB of the desired quality while maintaining the heating temperature as low as possible.

At this time, the atmosphere for the heating and stirring is maintained in a purged state by supplying an inert gas such as nitrogen, and heating is performed while stirring using a stirrer.

As the stirrer, a mechanical stirrer is used, and stirring is performed at a relatively low speed of 80 to 120 revolutions per minutes (RPM). The RPM of such a stirrer may vary depending on the viscosity and amount, and stirring may be performed in the range of 80 to 400 RPM.

By such heating, aluminum chloride, which has a low melting point, is melted, and the pitch evenly dispersed in the melt is heated evenly as a whole, so the heating efficiency may be increased compared to the method of directly heating powdered pitch.

Therefore, the present invention can induce a reaction at a lower temperature compared to the pitch reaction temperature known in the related art, and thus can save the energy required for MCMB preparation.

Next, the heated and stirred mixture is cooled, and the salt is removed therefrom as in Step S50.

At this time, the cooling is performed in an atmosphere where nitrogen is supplied to prevent a reaction with other foreign substances, and after the cooling is completed, the mixture is washed with distilled water to remove the salt, and thus mesophase pitch is obtained.

As mentioned above, both aluminum chloride and sodium chloride used in the present invention are water-soluble metal salts and are easily removed by washing with distilled water, and thus mesophase pitch may be obtained.

Next, the mesophase pitch from which the salt has been removed is post-processed to prepare MCMB as in Step S60.

At this time, the post-processing is to dry the mesophase pitch using an oven. After drying in a vacuum atmosphere at 40° C., a heat treatment reactant is removed from the dried mesophase pitch through solvent extraction to prepare MCMB.

The solvent extraction may be performed using a known extraction method such as extraction using heavy oil.

The MCMB prepared in this manner was confirmed to have excellent quality regardless of the quality of the raw pitch, and this is explained in more detail through the experimental examples below.

Specifically, the present invention is characterized by dispersing isotropic pitch in a molten metal salt and heat-treating it to obtain anisotropic mesophase pitch. To confirm the excellence of the MCMB preparation method of the present invention, a small-scale experiment was performed as described below. The properties of the MCMB prepared according to the present invention were confirmed through Raman spectroscopy and the like to confirm the effects of the present invention.

Experiment Examples FIG. 2 shows a graph illustrating the Raman spectroscopy results of isotropic pitch with a softening point of 150° C.

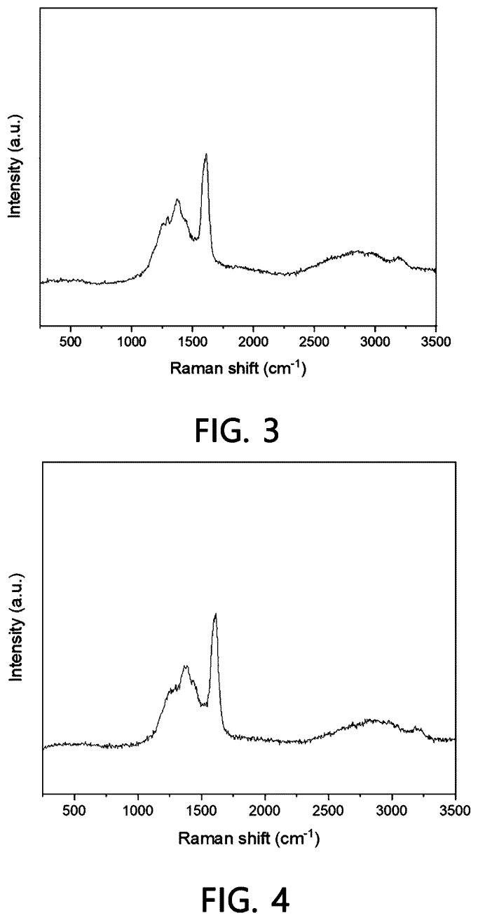

The present invention provides a method of obtaining anisotropic mesophase pitch using isotropic pitch with a softening point of 150° C. or 115° C. as a raw material, and FIG. 3 shows a graph illustrating the Raman spectroscopy results of anisotropic mesophase pitch that is intended to be obtained in the present invention.

The experiment was conducted multiple times by changing various conditions, as shown in Table 1 below.

For example, experiments were conducted by changing the type of the metal salt to a mixture of AlCl₃ and NaCl and a mixture of KCl and ZnCl₂, and the mixing ratio of the salts was also varied.

The pitch used as a feedstock in the experiments included anisotropic pitches represented by 1 and 2 and isotropic pitches represented by 3 and 4 in Table 1. The isotropic pitch represented by 3 is the above-described pitch with a softening point of 150° C., and the isotropic pitch represented by 4 is the pitch with a softening point of 115° C.

In addition, the temperature and time conditions of heat treatment were varied, and the stirring conditions of using a stirrer during heat treatment were also changed.

TABLE 1

| | | Experiment Description | | | | | | |
|---|---|---|---|---|---|---|---|---|
| | | | | Ratio of | Amount | Target | | Mech. S |
| Sr. | Experiment | | Applied | Feed | of | Temp. | Heating | timer |
| No. | Date | Feedstock | Salts | Salts | Salts | (° C.) | Time(min) | Applied |
| 1 | 2021 Oct. 19 | 1, 2, 3, 4 | N/A | 1:0 | N/A | ATM | 0 | No |
| 2 | 2021 Oct. 19 | 3 | AlCl3 + NaCl | 1:2 | 5 g | 300 | 120 | No |
| 3 | 2021 Oct. 22 | 3 | AlCl3 + NaCl | 1:10 | 5 g | 300 | 180 | No |
| 4 | 2021 Oct. 25 | 3 | AlCl3 + NaCl | 1:10 | 5 g | 250 | 180 | No |
| 5 | 2021 Oct. 31 | 3 | AlCl3 + NaCl | 1:2 | 5 g | 250 | 180 | No |
| 6 | 2021 Oct. 31 | 3 | AlCl3 + NaCl | 1:20 | 5 g | 250 | 180 | No |
| 7 | 2021 Nov. 8 | 1, 2, 3, 4 | N/A | 1:0 | N/A | 250 | 60 | No |
| 8 | 2021 Nov. 8 | 3 | KCl + ZnCl2 | 1:2 | 5 g | 300 | 180 | No |
| 9 | 2021 Nov. 8 | 3 | KCl + ZnCl2 | 1:10 | 5 g | 300 | 180 | No |
| 10 | 2021 Nov. 24 | 3 | AlCl3 + NaCl | 1:10 | 5 g | 250 | 180 | Yes |
| 11 | 2021 Nov. 30 | 3 | AlCl3 + NaCl | 1:10 | 10 g | 250 | 180 | Yes |
| 12 | 2021 Dec. 5 | 3 | AlCl3 + NaCl | 1:10 | 10 g | 200 | 180 | Yes |
| 13 | 2021 Dec. 7 | 1, 2, 3, 4 | N/A | 1:0 | N/A | ATM | 0 | No |
| 14 | 2021 Dec. 9 | 3 | N/A | 1:0 | N/A | 200 | 120 | No |
| 15 | 2021 Dec. 9 | 3 | AlCl3 + NaCl | 1:2 | 10 g | 200 | 180 | Yes |
| 16 | 2021 Dec. 16 | 3 | AlCl3 + NaCl | 1:20 | 10 g | 250 | 180 | Yes |
| 17 | 2021 Dec. 16 | 3 | AlCl3 + NaCl | 1:10 | 5 g | 200 | 180 | No |
| 18 | 2021 Dec. 22 | 3 | AlCl3 + NaCl | 1:10 | 10 g | 250 | 180 | Yes |
| 19 | 2021 Dec. 22 | 4 | AlCl3 + NaCl | 1:10 | 10 g | 250 | 180 | Yes |

As a result of the experiment, it was confirmed that when the KCl+ZnCl₂ mixture was used as a salt, the salt was not easily removed from the mesophase pitch and thus it could not be used.

Therefore, in the present invention, a water-soluble metal salt is used to provide a melt.

Among the experiments in Table 1, significant experimental results are described below.

### Experimental Result 1

As a significant experimental result, in Experiment No. 3 in Table 1, a mixture of aluminum chloride and sodium chloride was used as a molten salt, the pitch and salt were mixed at a ratio of 1:10 by weight and heat-treated at 300° C. for 180 minutes. At this time, stirring was omitted.

Mesophase pitch prepared under these conditions was prepared, the results were confirmed, and the Raman analysis results are shown in FIG. 4.

Referring to FIG. 4, it can be confirmed that the results of Experiment No. 3 were similar to the Raman shift results of FIG. 3. In other words, it was confirmed that anisotropic mesophase pitch may be prepared even when using isotropic pitch.

In addition, it could be confirmed that processing for MCMB preparation was possible even at a relatively low temperature.

However, despite heating to 300° C., some vaporization of the pitch and molten salt mixture was observed.

### Experimental Result 2

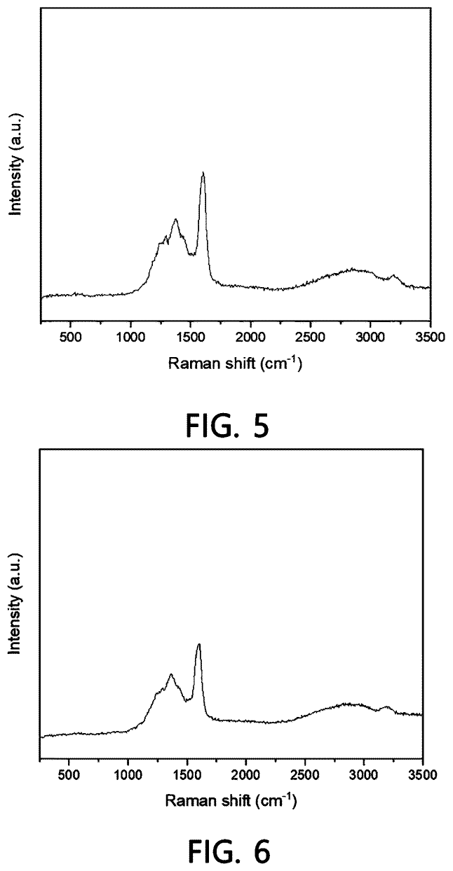

The results of Experiment No. 4 are shown in FIG. 5.

Experimental Result 2 was obtained by maintaining other factors the same as the conditions of the above-described Experiment No. 3, except that the heating temperature was lowered to 250° C.

Even when the temperature was lowered to 250° C., the obtained results were similar to the Raman shift results in FIG. 3, and the preparation costs could be further reduced by further lowering the heating temperature.

In particular, since no vaporization occurred, a Raman shift graph more similar to that of FIG. 3 could be confirmed compared to the results of Experiment No. 3.

### Experimental Result 3

The Raman shift resulting from Experiment No. 17 is shown in FIG. 6.

Experiment No. 17 was performed under the conditions of Experiment No. 3, with only the heating temperature lowered to 200° C. It was confirmed that the Raman shift results were similar to the above-described results in FIGS. 4 and 5, but the intensity (a.u.) of the peak was reduced.

Based on the above experimental results, it is preferable to apply heating conditions of 150 to 300° C. in the present invention, and in particular, when heating was performed at 250° C., results most similar to the target results could be obtained.

The above experiments were intended to confirm the heating temperature conditions, and in order to confirm the appropriate degree of heating maintenance time, the heating time was changed under the same conditions as the above experiments while fixing the temperature at 250° C., and the properties were analyzed.

### Experimental Result 4

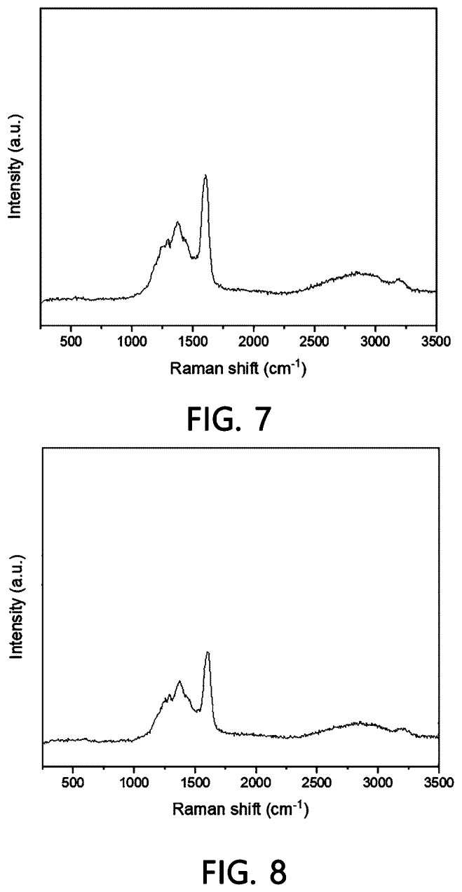

The basic experimental conditions were the same as Experiment No. 4, but the heating time was shortened from 180 minutes to 120 minutes, and the results are shown in FIG. 7.

As shown in FIG. 7, it could be confirmed that even though the heating time was shortened to 120 minutes, the Raman shift results were very similar to the target results.

### Experimental Result 5

Under the experimental conditions of Experiment No. 4, the heating time was further shortened to 60 minutes, and the results are shown in FIG. 8.

It was confirmed that the shape of the Raman shift was similar to Experimental Result 5 where the heating time was maintained at 120 minutes, but the intensity was lowered.

Through these various experiments, it was confirmed that anisotropic mesophase pitch may be prepared while using low-quality isotropic pitch when the treatment is performed at a heating temperature in the range of 150 to 300° C. for a heating time of 30 to 180 minutes.

To obtain more diverse experimental results, experiments were performed while adjusting the mixing ratio of the isotropic pitch and salt.

### Experimental Result 6

The experimental conditions of Experiment No. 4 are an example of using a mixture of aluminum chloride and sodium chloride and preparing the mixture of the isotropic pitch and salt by mixing them at a weight ratio of 1:10, and this ratio was changed to 1:2 under the experimental conditions of Experiment No. 5.

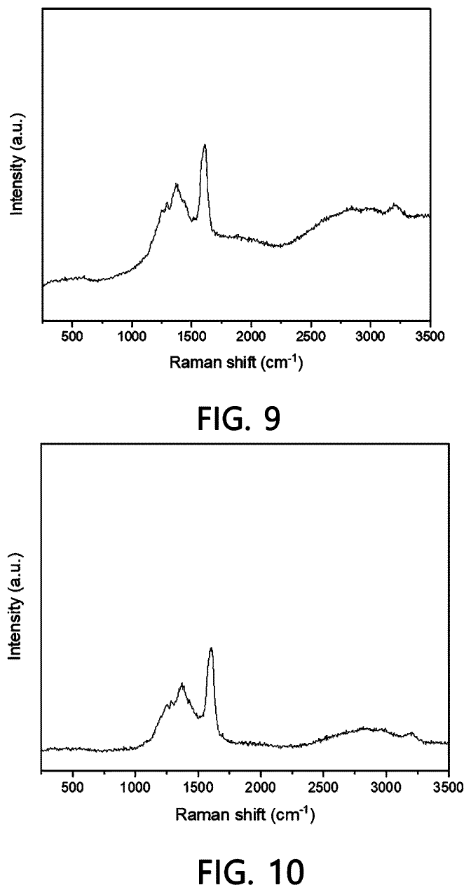

The results of the experiment under the conditions of Experiment No. 5 are shown in FIG. 9.

As shown in FIG. 9, it was confirmed that there was a large difference from the target Raman shift results.

This may be because the amount of the molten salt dispersed in the isotropic pitch was small, making it impossible to heat the isotropic pitch evenly.

### Experimental Result 7

Unlike Experiment No. 5, in Experiment No. 6, the mixing weight ratio of the isotropic pitch and salt in the mixture was increased to 1:20.

The results of this experiment are shown in FIG. 10.

The shape of the Raman shift was similar to the target results, but the peak intensity was slightly lower.

Based on these experimental results, it was confirmed that the isotropic pitch and the salt may suitably be mixed at a mixing ratio of 5 to 30% by weight of the isotropic pitch and 70 to 95% by weight of the salt in the mixture.

### Experimental Result 8

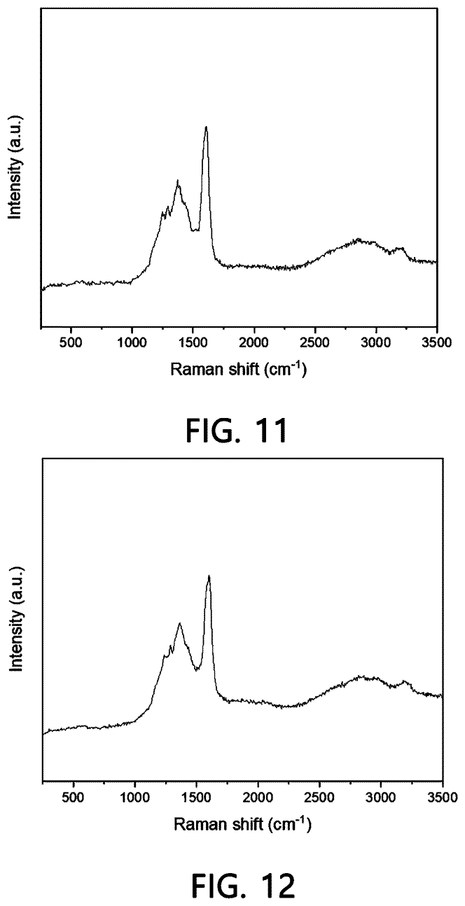

In addition, to evaluate the effect of stirring during heating, stirring was performed in Experiment No. 11 using a stirrer under the same conditions as Experiment No. 4, and the results are shown in FIG. 11.

Referring to FIG. 11, results more similar to the target results even compared to the results obtained without stirring (see FIG. 7) could be obtained.

It was demonstrated that stirring the molten salt in a heated state can improve the uniformity of heat distribution to heat the isotropic pitch more uniformly, thereby exhibiting better properties.

Finally, an experiment was performed to confirm whether mesophase pitch of excellent quality may be obtained even when the present invention was applied to isotropic pitch with a softening point of 115° C.

### Experimental Result 9

In Experiment No. 19 in Table 1, isotropic pitch of grade 115 was used, a mixture of aluminum chloride and sodium chloride was used as a molten salt, the weight ratio of the isotropic pitch and molten salt was 1:10, heating was performed at a heating temperature of 250° C. for 180 minutes, and the molten salt was stirred during the heating.

The results obtained from this experiment are shown in FIG. 12.

As can be seen in FIG. 12, even when isotropic pitch of grade 115 was used, a mesophase pitch of excellent quality could be obtained.

Therefore, the present invention enables MCMB of desired quality to be prepared even using cheaper raw pitch, thereby minimizing preparation costs.

It is obvious to those skilled in the art that the present invention is not limited to the above embodiments and can be implemented with various changes and modifications without departing from the technical gist of the present invention.

### INDUSTRIAL APPLICABILITY

The present invention relates to a method of converting isotropic pitch to anisotropic pitch using natural laws while saving energy and thus has industrial applicability.

1. A mesophase carbon microbead (MCMB) preparation method comprising the steps of:
a) pre-treating raw pitch;
b) mixing the pre-treated pitch with a salt;
c) pulverizing and stirring the mixture of the pitch and salt;
d) heating and stirring the pulverized mixture at a temperature of 150 to 300° C. for 30 to 180 minutes to pyrolyze and polymerize the raw pitch and consequently prepare mesophase pitch;
e) cooling the heated and stirred mixture and removing the salt therefrom; and
f) post-processing the mesophase pitch from which the salt has been removed to prepare CMB.

2. The MCMB preparation method of claim 1, wherein the raw pitch is isotropic pitch with softening point of 150° C. or 115° C.

3. The MCMB preparation method of claim 1, wherein Step a) is to homogenize dried raw pitch to a particle size of 106 μm or less through sieving and dry the homogenized raw pitch in an oven.

4. The MCMB preparation method of claim 1, wherein the salt of Step b) is a water-soluble metal chloride.

5. The MCMB preparation method of claim 4, wherein the metal chloride is a mixture of aluminum chloride and sodium chloride in a molar ratio of 3:2 to 1:1.

6. The MCMB preparation method of claim 4, wherein the mixing ratio of the raw pitch and the metal chloride is 5 to 30% by weight of the raw pitch and 70 to 95% by weight of the salt.

7. The MCMB preparation method of claim 4, wherein Step e) is to remove the water-soluble salt by washing with distilled water.

8. The MCMB preparation method of claim 1, wherein Step f) is to dry the mesophase pitch in a vacuum atmosphere and then prepare MCMB through solvent extraction.

9. The MCMB preparation method of claim 2, wherein Step a) is to homogenize dried raw pitch to a particle size of 106 μm or less through sieving and dry the homogenized raw pitch in an oven.

10. The MCMB preparation method of claim 2, wherein the salt of Step b) is a water-soluble metal chloride.

11. The MCMB preparation method of claim 10, wherein the metal chloride is a mixture of aluminum chloride and sodium chloride in a molar ratio of 3:2 to 1:1.

12. The MCMB preparation method of claim 10, wherein the mixing ratio of the raw pitch and the metal chloride is 5 to 30% by weight of the raw pitch and 70 to 95% by weight of the salt.

13. The MCMB preparation method of claim 10, wherein Step e) is to remove the water-soluble salt by washing with distilled water.
